(19) United States
(12) Patent Application Publication
(10) Pub. No.: US 2026/0365796 A1
(43) Pub. Date: Nov. 19, 2026

(54) PROCESS FOR CONVERTING A LIGNOCELLULOSIC BIOMASS

(71) Applicant: UOP LLC, Rosemont, IL (US)

(72) Inventors: Gregory B. Kuzmanich, Arlington Heights, IL (US); Susie C. Martins, Carol Stream, IL (US)

(21) Appl. No.: 19/467,453

(22) Filed: Feb. 2, 2026

Related U.S. Application Data
(60) Provisional application No. 63/805,740, filed on May 14, 2025.

(51) Int. Cl. C08H 8/00

(52) U.S. Cl. CPC C08H 8/00

(57) ABSTRACT

A process for converting a lignocellulosic biomass is disclosed. The process comprises charging a lignocellulosic biomass stream and a solvent stream to a reactor. The solvent stream comprises an alcohol and an aromatic. The lignocellulosic biomass stream and said solvent stream are contacted with a catalyst in the presence of hydrogen in a reactor to produce a reactor effluent stream. The reactor effluent stream is separated into a first stream comprising the alcohol and a second stream comprising the aromatic and a lignin derived stream. The aromatic solvent stream is separated from lignin derived stream in an aromatic solvent column to produce a lignin derived stream.

### FIELD

The field is a process for converting a lignocellulosic biomass. The field may particularly relate to a process for converting a lignocellulosic biomass in a solvent stream.

### BACKGROUND

Biomass refining or biorefining is becoming more prevalent in industry. Cellulose fibers and sugars, hemicellulose sugars, lignin, syngas, and derivatives of these intermediates are being used by many stakeholders for chemical and fuel production. These producers are capable of processing incoming biomass much the same way as petroleum refineries now process crude oil. Underutilized lignocellulosic biomass feedstocks have the potential to be much cheaper than petroleum, on a carbon basis, as well as having a much better environmental life-cycle.

Lignocellulosic biomass is the most abundant renewable material on the planet. The lignocellulosic biomass is a potential feedstock for producing chemicals, fuels, and other useful materials. Lignocellulosic biomass normally comprises primarily cellulose, hemicellulose, and lignin. Cellulose and hemicellulose are natural polymers of sugars, and lignin is a hydrocarbon polymer that reinforces the entire biomass organism. Some forms of biomass (e.g., recycled materials) do not contain hemicellulose. Lignocellulosic material includes, but is not limited to, wood, forestry waste, sawdust, straw, corn stover, sugarcane bagasse, switchgrass, and other lignin and cellulose containing materials of biological origin. Lignin bonds to the cellulose and has a molecular structure of a cross-linked phenolic polymer having an abundance of aromatic rings. Lignin is generally present in lignocellulosic material in an amount of about 15 to about 30 percent by weight.

It is beneficial to process biomass in a way that effectively separates the major fractions (cellulose, hemicellulose, and lignin) from each other. Cellulose from biomass can be used in industrial cellulose applications directly, such as to make paper or other pulp-derived products. The cellulose can also be subjected to further processing to either modify the cellulose in some way or convert it into glucose. Hemicellulose sugars can be fermented to a variety of products, such as ethanol, or converted to other chemicals. Lignin from biomass has value as a solid fuel and also as an energy feedstock to produce liquid fuels, synthesis gas, or hydrogen; and as an intermediate to make a variety of polymeric compounds. Additionally, minor components such as proteins or rare sugars can be extracted and purified for specialty applications.

Great importance has been attached to renewable energy resources all over the world. Ethanol fuel derived from biomass is one of the routes for producing renewable fuels. The processes of producing ethanol fuel from starch and cellulose are under modification and improvement. The use of lignocellulosic biomass as a source of renewable raw material is a leading area for the replacement of petroleum products.

Attempts to use lignin as a feedstock for the production of chemicals or transportation fuel blending components continue to prove commercially impractical due to the high associated costs, as well as the limited conversion to these desired end products. Consequently, improvements in methods for converting lignocellulosic biomass to valuable products are continually being sought.

### BRIEF SUMMARY

A process for converting a lignocellulosic biomass is disclosed. The process comprises charging a lignocellulosic biomass stream and a solvent stream to a reactor. The solvent stream comprises an alcohol and an aromatic. The lignocellulosic biomass stream and said solvent stream are contacted with a catalyst in the presence of hydrogen in a reactor to produce a reactor effluent stream. The reactor effluent stream is separated into a first stream comprising the alcohol and a second stream comprising the aromatic and a lignin derived effluent. The aromatic solvent stream is separated from lignin derived effluent in an aromatic solvent column to produce a lignin derived stream.

### BRIEF DESCRIPTION OF THE DRAWINGS

FIG. 1 is a schematic drawing of a process for converting a lignocellulosic biomass in accordance with an embodiment of the present disclosure.

FIG. 2 is a schematic drawing of a process for converting a lignocellulosic biomass in accordance with another embodiment of the present disclosure.

FIG. 3 is a schematic drawing of a process for converting a lignocellulosic biomass in accordance with yet another embodiment of the present disclosure.

### DEFINITIONS

The term “communication” means that fluid flow is operatively permitted between enumerated components, which may be characterized as “fluid communication”.

The term “downstream communication” means that at least a portion of fluid flowing to the subject in downstream communication may operatively flow from the object with which it fluidly communicates.

The term “upstream communication” means that at least a portion of the fluid flowing from the subject in upstream communication may operatively flow to the object with which it fluidly communicates.

The term “direct communication” means that fluid flow from the upstream component enters the downstream component without passing through any other intervening vessel.

The term “indirect communication” means that fluid flow from the upstream component enters the downstream component after passing through an intervening vessel.

The term “bypass” means that the object is out of downstream communication with a bypassing subject at least to the extent of bypassing.

As used herein, the term “predominant” or “predominate” means greater than 50%, suitably greater than 75% and preferably greater than 90%.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take main product from the bottom.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure. As used herein, the term “boiling point temperature” means atmospheric equivalent boiling point (AEBP) as calculated from the observed boiling temperature and the distillation pressure, as calculated using the equations furnished in ASTM D1160 appendix A7 entitled “Practice for Converting Observed Vapor Temperatures to Atmospheric Equivalent Temperatures”.

As used herein, the term “biomass” includes any non-fossilized, i.e., renewable, organic matter. The various types of biomass include plant biomass, microbial biomass, animal biomass, such as, animal by-product, animal waste, etc. and municipal waste biomass.

As used herein, the term “biofuel,” means a fuel product at least partly derived from “biomass,” the latter being a renewable resource of biological origin.

As used herein, the term “lignin,” means a complex chemical polymer found in all vascular plants, most commonly derived from wood, and generally being an integral part of the secondary cell walls of plants.

As used herein, the term “cellulose,” means essentially a crystalline glucose polymer by virtue of it being a linear polysaccharide comprised of hundreds to thousands of D-glucose monomeric units linked via glycosidic bonds.

As used herein, the term “hemicellulose,” means any of several heteropolysaccharides present in almost all plant cell walls along with cellulose. In contrast to cellulose, hemicellulose is commonly branched, typically shorter in length and lower in molecular weight (a few hundred to a few thousand saccharide units), and contains many different sugar monomers such as, but not limited to, glucose, xylose, mannose, galactose, rhamnose, and arabinose.

As used herein, the term “lignocellulosic,” means plant biomass that is composed of cellulose, hemicellulose, and lignin.

### DETAILED DESCRIPTION

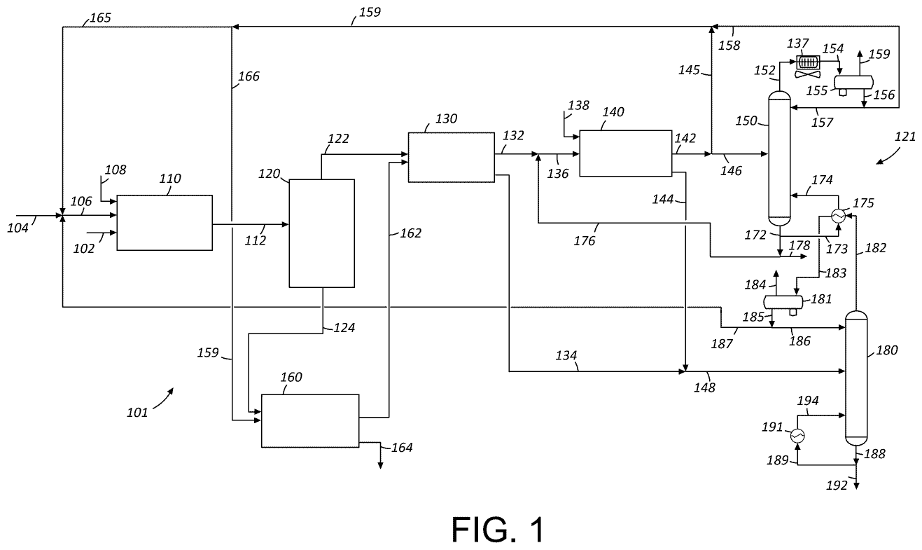

Referring to FIG. 1, a process 101 for converting a lignocellulosic biomass material is disclosed. The process comprises a reactor 110 and a separation section 121. A biomass stream in line 102 may be charged to the reactor 110. In an exemplary embodiment, the biomass stream in line 102 is a lignocellulosic biomass stream. The lignocellulosic biomass used as a feedstock in the present disclosure may be obtained from a variety of biomass sources, and particularly residues from wood and crops, including forestry waste, sawdust, straw, corn stover, and bagasse. Lignin is understood in the art to refer to the cross-linked, polymeric macromolecule that bonds to cellulose and hemicellulose, thereby conferring strength to a plant (e.g., wood) cell walls.

Cellulosic biomass may be defined as biomass containing cellulose. Here, biomass may refer to substances having their edible parts removed but still rich in biomass energy, such as crop straw, bamboo, reed, trees, leaves, weeds and hydrophytes, etc. The main constituents of such cellulosic biomass may include polysaccharide celluloses, hemicelluloses, and lignin of polyaromatic compounds. Lignocellulosic biomass is composed of three main constituents: cellulose, hemicellulose, and lignin. Hemicellulose is a polysaccharide essentially consisting of pentoses and hexoses. Lignin is a macromolecule of complex structure and high molecular weight, composed of aromatic alcohols connected by ether bonds. The three basic building blocks of lignin, p-coumaryl alcohol, coniferyl alcohol, and sinapyl alcohol, are synthesized via the phenylpropanoid pathway in plants and differ in their extent of methoxylation (0, 1, and 2, respectively). Lignin is synthesized via enzymatic dehydrogenation of these monomers, which form both C—O and C—C bonds, leading to a heterogeneous structure and a three-dimensional structure.

Cellulose and lignin represent two of the most prominent renewable carbon sources. Lignin, the second most plentiful renewable carbon source on earth, is an amorphous three-dimensional energy-rich phenolic biopolymer, which is deposited in all vascular plants and provides rigidity and strength to their cell walls. The lignin polymeric structure is composed primarily of three phenylpropanoid building units: p-hydroxyphenylpropane, guaiacylpropane, and syringylpropane interconnected by etheric and carbon-to-carbon linkages. Generally, in unprocessed lignin, two thirds or more of these linkages are ether bonds, while the remaining linkages are carbon-carbon bonds.

Different types of lignin differ significantly in the ratio between these monomers. Inherent in its molecular nature, the lignin bio-mass component can potentially be converted directly to liquid fuels, for example high-octane alkylbenzene, sustainable aviation fuel, aromatic ether gasoline-blending components, and/or naphthenic kerosene fuels.

In an aspect, the lignocellulosic biomass may be subjected to a chemical pre-treatment step in the biomass processing unit. Some “pretreatment” of the biomass may be carried out prior to attempting the enzymatic hydrolysis of the cellulose and hemicellulose in the biomass. Pretreatment refers to a process that converts lignocellulosic biomass from its native form, in which it is resistant to cellulase enzyme systems, into a form for which cellulose hydrolysis is effective. Compared to untreated biomass, effectively pretreated lignocellulosic materials may be characterized by an increased surface area (porosity) accessible to cellulase enzymes, and solubilization or redistribution of lignin. Increased porosity results mainly from a combination of disruption of cellulose crystallinity, hemicellulose disruption/solubilization, and lignin redistribution and/or solubilization. The relative effectiveness in accomplishing at least some of these factors differs greatly among different existing pretreatment processes.

The purpose of the pretreatment is to significantly disrupt the structure of biomass in order to: (a) reduce the crystallinity of cellulose, (b) increase accessibility/susceptibility of cellulose and hemicellulose chains to enzymes or catalysts by increasing the surface area and porosity and (c) remove lignin. Thermo-chemical biomass pretreatments techniques may be used for improving the digestibility of the highly recalcitrant biomass. These pretreatments may include dilute acid contact, steam explosion, hydrothermal pyrolysis, dissolution in organic solvents in an aqueous medium, ammonia fiber explosion, contact with strong alkali using a base such as ammonia, sodium hydroxide or lime, and highly concentrated phosphoric acid contact.

In some embodiments, the lignocellulosic biomass may be subjected to size reduction treatment to form a finely ground lignocellulosic biomass. In an aspect, the lignocellulosic biomass may be introduced to a milling device to form a finely ground lignocellulosic biomass. The milling device may be any device capable of milling or grinding biomass into particles. In an exemplary embodiment, the lignocellulosic biomass may be finely ground via the milling device to an average particle size of from about 0.05 to about 10 mm to form the finely ground lignocellulosic biomass.

Referring back to FIG. 1, a solvent stream in line 104 is also charged to the reactor 110. In an aspect, a fresh solvent stream, such as a solvent which is not used before, may be taken in line 104. As described later in detail, the solvent stream in line 104 may be combined with one or both recycle solvent streams in line 165 and 187 to provide a combined solvent stream in line 106. The combined solvent stream in line 106 may be charged to the reactor 110. In an alternate embodiment, the combined solvent stream in line 106 and the lignocellulosic biomass stream in line 102 may be heated in a charge heater before charging to the reactor 110. A heated charge stream comprising the lignocellulosic biomass stream and the solvent stream may be charged to the reactor 110. The reactor 110 may be an ebullated bed reactor that contains catalyst, for example, catalyst preloaded into the reactor 110. Alternatively, the reactor 110 may be a slurry reactor where the catalyst moves through the reactor 22 from an inlet to an outlet. In an embodiment, the reactor 110 may comprise more than one reactor vessel for contacting the combined solvent stream in line 106 and the lignocellulosic biomass stream in line 102.

In an aspect of the present disclosure, the combined solvent stream in line 106 may comprise two solvents. The combined solvent stream in line 106 comprising two solvents helps in reducing the energy consumption of the process by about 50 to about 70%.

In an exemplary embodiment of the present disclosure, the combined solvent stream in line 106 may comprise an alcohol and an aromatic. In an aspect, the solvent stream in line 104 comprises a fresh alcohol stream, such as an alcohol stream which is not used before, and a fresh aromatic stream, such as an aromatic stream which is not used before. The solvent stream in line 104 may comprise some amount of water present with the alcohol.

In an aspect, the alcohol in the solvent stream in line 104 has no more than four carbon atoms. In an embodiment, the alcohol in the solvent stream in line 104 may be selected from methanol, ethanol, propanol, ethylene glycol, and isobutanol. In an exemplary embodiment, the alcohol in the solvent stream in line 104 may comprise methanol.

In another aspect, the aromatic in the solvent stream in line 104 may comprise about six to twenty carbon atoms, preferably about six to fourteen carbon atoms. In an exemplary embodiment, the aromatic in the solvent stream in line 104 may comprise toluene.

The solvent stream in line 104 may be prepared by mixing an alcohol stream with an aromatic solvent stream. In an embodiment, the alcohol stream may comprise from about 3 wt % to about 15 wt % water, or about 4 wt % to about 10 wt % water, preferably about 5 wt % to about 8 wt % water.

In an aspect, the solvent stream in line 104 may comprise from about 40 vol % to about 60 vol % alcohol and from about 60 vol % to about 40 vol % aromatic solvent. In an exemplary embodiment, the solvent stream in line 104 may comprise an alcohol and an aromatic in a ratio of about 2:3 to about 3:2 by volume. In an exemplary embodiment, the solvent stream in line 104 may comprise from about 3 wt % to about 15 wt % water with the alcohol.

Referring back to the reactor 110, a hydrogen stream in line 108 may be charged to the reactor 110. In the reactor 110, the lignocellulosic biomass stream in line 102 and the combined solvent stream in line 106 may be contacted with hydrogen in the presence of a catalyst to produce a reactor effluent stream. The catalyst may be added into either of the solvent stream in line 104, the combined solvent stream in line 106 and the lignocellulosic biomass stream in line 102 and charged to the reactor 110. Alternatively, a catalyst stream may be added into the reactor separately.

The reaction conditions in the reactor 110 may include a solvent to biomass ratio of about 3:2 to about 5:1 by weight. In the reactor 110, the lignocellulosic biomass and the solvent stream may contact hydrogen in the presence of the catalyst under conditions that promote the depolymerization of the lignocellulosic material to aromatic oxygenated substitute, for example, phenol and its alkoxylated derivatives and the deoxygenation and, to some level, decarboxylation of these substitutions or intermediates to aromatic hydrocarbons, forming an aromatic hydrocarbon-rich reactor effluent. The catalyst may be in the form of solid particles comprising catalytically active metal disposed on a support.

The aromatic solvent in the solvent stream 104 has a higher boiling point than the alcohol stream. The higher boiling point aromatic solvent enables operating the reactor 110 at a lower pressure and the lignin derived products, produced after the contacting step, is dissolved int the aromatic solvent. The lignin derived products can be separated from the aromatic solvent with a comparative ease.

The reaction conditions in the reactor 110 for the catalytic depolymerization and deoxygenation of the lignocellulosic biomass may be adjusted depending on the quality of the lignocellulosic material to improve the level of conversion to aromatic hydrocarbons. The reactor 110 may be operated at a pressure of no more than about 15 MPa (gauge). In an exemplary embodiment, reaction conditions in the reactor 110 may include a temperature of from about 50 °C (122 °F) to about 350 °C (662 °F), and preferably from about 100 °C (212 °F) to about 250 °C (482 °F), and a pressure of about 5000 kPa (gauge) (725 psig) to about 15000 kPa (gauge) (2176 psig), and preferably of from about 6500 kPa (gauge) (943 psig) to about 8000 kPa (gauge) (1160 psig).

The residence time of the reactor 110 may also be adjusted depending on the quality of the lignocellulosic biomass to improve the level of conversion of the lignocellulosic material to aromatic hydrocarbons. In particular, lower residence times are associated with lower levels of conversion of the lignocellulosic material to aromatic hydrocarbons. The inverse of the residence time is weight space velocity, which is the weight flow rate of the lignocellulosic biomass in line 102 divided by the catalyst weight. Increasing the Weight Hourly Space Velocity (WHSV) directionally decreases residence time and consequently the extent of the depolymerization and deoxygenation conversion reactions. In an exemplary embodiment, the WHSV of the lignocellulosic biomass stream in line 102 may be from about 0.1 hr⁻¹ to about 20 hr⁻¹, and preferably from about 0.2 hr⁻¹ to about 10 hr⁻¹. The quantity of hydrogen used may be based on the stoichiometric amount needed to completely convert the oxygen present in the lignocellulosic material to H₂O. The reaction may be carried out in the presence of hydrogen in an amount of from about 90% to about 600% of the stoichiometric amount.

In an alternate embodiment, the lignocellulosic biomass stream in line 102 may be mixed with the combined solvent stream in line 106 to provide a mixed feed stream comprising a solvent to biomass ratio of about 3:2 to about 5:1 by weight. The mixed feed stream may be charged into the reactor 110 and contacted with hydrogen in the presence of the catalyst.

Under the operating conditions, greater than about 60% lignin, preferably greater than about 65% lignin of the lignocellulosic biomass stream may be converted into lignin derived products, such as lignin oil. Overall, the hemicellulose conversion may be greater than about 80 wt %, preferably greater than about 85 wt %. The cellulose conversion may be less than about 20 wt %, preferably less than about 10 wt %, or more preferably less than about 5 wt %. Further, under the reaction conditions and the catalyst, the reactor effluents produced from the conversion of the lignocellulosic biomass comprises a greater amount of dimers than the monomers.

The aromatic rich reactor effluent stream may be taken in line 112 from the reactor 110. The reactor effluent stream in line 112 may comprise a dimers to monomers ratio of greater than about 1:1 by weight. In an exemplary embodiment, the reactor effluent stream in line 112 may comprise from about 60 wt % to about 70 wt % dimers and from about 40 wt % to about 30 wt % monomers. The reactor effluent stream in line 112 may comprise solids, lignin derived products including lignin oil, some dissolved sugars with the aromatic solvent and the alcohol from the solvent stream. The reactor effluent stream in line 112 may be passed to the separation section 121 to separate the solids, and the solvent from the lignin derived products. The separation section 121 may comprise a solids separator 120, an alcohol recovery column 150, and an aromatic solvent column 180.

In an embodiment, the reactor effluent stream in line 112 may be fed to a solids separator 120 to removed solids. In an exemplary embodiment, the solids separator 120 may be a centrifuge. Other suitable techniques may be used to separated solids from the reactor effluent stream. Solids may be removed and taken in line 124 from the solids separator 120. A two-phase liquid stream may be taken in line 122 from the solids separator 120. The two-phase liquid stream comprises the lignin derived products along with alcohol solvent and the aromatic solvent which may be separated. The two-phase liquid stream may be taken in line 122 from the overhead of the solids separator 120 and the solids stream may be taken in line 164 from the bottom of the solids separator 120. In an aspect, the solids stream in line 164 may comprise cellulosic biomass.

In an aspect, the two-phase liquid stream in line 122 may be cooled and passed to a two-phase separator 130. In the two-phase separator 130, the alcohol solvent is separated from the aromatic solvent to produce a first stream comprising the alcohol, and a second stream comprising the aromatic solvent and a lignin derived effluent. The two-phase separator 130 may be operated at a temperature of about 37 °C (100 °F) to about 90 °C (194 °F) and a pressure of about atmospheric pressure.

In some embodiments, the process 101 may comprise a single, or multiple, separators for separating solids and produce the first stream comprising the alcohol, and the second stream comprising the aromatic solvent and a lignin derived stream.

In the two-phase separator 130, the alcohol may be separated in a light phase and the aromatic solvent may be separated in a heavier phase. Alcohol may be taken from a location above the phase containing the aromatic solvent in the two-phase separator 130. In an aspect, the first stream comprising the alcohol and water may be taken in line 132 from the two-phase separator 130. The first stream in line 132 comprises sugars which can be recovered from the first stream. The first stream in line 132 may comprise some aromatic solvent which must be removed prior to the recovery of sugars. In an aspect, the first stream in line 132 may comprise from about 5 wt % to about 15 wt % aromatic solvent.

In an embodiment, the first stream in line 132 may be fed to a washing column 140 for separating the aromatic solvent. An aqueous sugar stream in line 176 may be combined with the first stream in line 132 to provide a combined first stream in line 136. The combined first stream in line 136 may be fed to the washing column 140. In an exemplary embodiment, the combined first stream in line 136 may be fed to the washing column 140 near the bottom of the column. In the washing column 140, the combined first stream may be washed with a washing stream such as an aromatic solvent stream in line 138 to remove the aromatic solvent from the alcohol and sugars. In another exemplary embodiment, the aromatic solvent stream in line 138 may be fed to the washing column 140 near the top of the column. A washed first stream comprising alcohol, water, and sugars may be taken in line 142 from the washing column 140. A contacted aromatic solvent stream may be taken in line 144 from the washing column 140. In an embodiment, the combined first stream in line 136 may be counter-currently contacted with the aromatic solvent stream in line 138. In such an embodiment, the contacted aromatic solvent stream in line 144 may be taken from the bottom of the washing column 140 and the sugars may be taken in line 142 from the overhead of the washing column 140. The washing column 140 may be operated at a temperature of about 15 °C (60 °F) to about 38 °C (100 °F) and a pressure of about 34 kPa (gauge) (5 psig) to about 138 kPa (gauge) (20 psig).

In an exemplary embodiment, a bypass stream may be taken in a bypass line 145 from the washed first stream in line 142. The bypass stream can be taken in line 145 to reduce energy utilized in the column 150 if the alcohol purity in line 157 is sufficient without further separation of the bypass stream. The remaining washed first stream may be taken in line 146 and fed to the alcohol recovery column 150. In an aspect, the alcohol recovery column 150 may be operated at a lower pressure than the aromatic solvent column 180. The alcohol recovery column 150 may be operated at an overhead pressure of about 7 kPa (gauge) (1 psig) to about 42 kPa (gauge) (6 psig) and a bottom temperature of about 90 °C (194 °F) to about 140 °C. (284 °F).

In the alcohol recovery column 150, the alcohol is separated from the heavier sugars. An overhead stream comprising the alcohol in line 152 may be cooled in a cooler condenser 137 and partially condensed to produce a cooled overhead stream in line 154 and passed to an overhead receiver 155 of the alcohol recovery column 150. An offgas stream in line 159 may be vented from the receiver 155. The overhead receiver 155 may be operated at a temperature of about 60 °C (140 °F) to about 100 °C. (212 °F). An overhead liquid stream comprising the alcohol may be taken from the overhead receiver in line 156. A reflux stream in line 157 may be taken from the overhead liquid stream and recycled to the alcohol recovery column 150 near the top of the column. A recycle alcohol stream may be taken in line 158 and recycled to the reactor 110 via lines 159, 165 and 106. recycled

In an aspect, the recycle alcohol stream in line 158 may be combined with the bypass stream in line 145 to provide a combined recycle alcohol stream in line 159. The combined recycle alcohol stream in line 159 may be recycled to the reactor 110. In an exemplary embodiment, a first recycle alcohol stream in line 165 and a second recycle alcohol stream in line 166 may be taken from the combined alcohol stream in line 159. The first recycle alcohol stream in line 165 may be combined with the solvent stream in line 104 and charged to the reactor 110 in line 106 as previously described.

In an embodiment, the second recycle alcohol stream in line 166 may be passed to a solids washing column 160 to wash the solids containing stream in line 124. In an embodiment, the solids containing stream in line 124 may be cooled to a temperature of about 30 °C. (86 °F) to about 60 °C (140 °F) before entering the solids washing column 160. The solids containing stream in line 124 may be fed near the bottom of the solids washing column 160 and the second recycle alcohol stream in line 159 may be fed near the top of the solids washing column 160. The ratio of the second recycle alcohol stream in line 159 to the solids in the solids washing column 160 may range from about 2:1 to about 5:1 by weight. In the solids washing column 160, the solids containing stream in line 124 may be contacted counter-currently with the second recycle alcohol stream in line 159 to wash the solvent off the solids. Washed solids may be taken in line 164 from the bottom of the solids washing column 160. A contacted second alcohol stream may be taken from the overhead of the solids washing column 160 in line 162. In an exemplary embodiment, the contacted second alcohol stream in line 162 may be charged to the two-phase separator 130.

An aqueous sugar stream may be produced in line 172 from the bottom of the alcohol recovery column 150. A reboiling stream in a reboil line 173 may be taken from the bottom aqueous sugar stream in line 172. The reboiling stream in line 173 may be reboiled in a reboiler 175 with a suitable heating media to provide a reboiled stream in line 174. In an aspect, the reboiling stream in line 173 may be reboiled in the reboiler 175 with a process stream. In an exemplary embodiment, the reboiling stream in line 173 may be reboiled in the reboiler 175 by heat exchange with an overhead stream in line 182 of the aromatic solvent column 180. Reboiling the alcohol column 150 directly with the overhead of the aromatic solvent column 180 provides tremendous energy savings. The reboiled stream in line 174 is recycled back to the alcohol recovery column 150 near the bottom. In an aspect, a recycle aqueous sugar stream may be taken in line 176 from the bottom aqueous sugar stream and fed to the washing column 140. The recycle aqueous sugar stream in line 176 may be combined with the first stream in line 132 to provide the combined first stream in line 136. The water from the recycle aqueous sugar stream in line 176 when combined with the first stream in line 132 can further enhance the separation of the aromatic solvent from alcohol in the washing column 140. The amount of water present in the combined first stream in line 136 may affect the polarity and enhances the separation of the aromatic solvent from alcohol in the washing column 140. In an embodiment, the combined first stream in line 136 may comprise about 5 wt % to about 15 wt % water. The remainder of the aqueous sugar stream may be taken in line 178 from the alcohol recovery column 150.

Referring back to the two-phase separator 130, the second stream may be taken in line 134 from the two-phase separator 130. The second stream comprises the lignin derived products with the aromatic solvent which must be separated to recover the lignin derived products. In an embodiment, the second stream in line 134 may be fed to the aromatic solvent column 180 to recover the lignin derived products. In an exemplary embodiment, the second stream in line 134 may be combined with the contacted aromatic solvent stream in line 144 to provide a combined second stream in line 148. The combined second stream in line 148 may be charged to the aromatic solvent column 180. In the aromatic solvent column 180, the combined second stream in line 148 may be fractionated to separate the aromatic solvent from the lignin derived product stream.

In an aspect, the aromatic solvent column 180 may be operated at a higher pressure than the alcohol recovery column 150. The aromatic solvent column 180 may be operated at an overhead pressure of about 275 kPa (gauge) (40 psig) to about 552 kPa (gauge) (80 psig) and a bottom temperature of about 80 °C (176 °F) to about 120 °C (248 °F).

In the aromatic solvent column 180, the aromatic solvent is separated from the lignin derived products. An aromatic column overhead stream comprising the aromatic solvent may be taken in line 182 from the overhead of the aromatic solvent column 180. In an exemplary embodiment, the aromatic column overhead stream in line 182 may be passed to the reboiler 175 of the alcohol recovery column 150 for heating the reboiling stream in line 173. In the reboiler 175, the aromatic column overhead stream in line 182 may be heat exchanged with the reboiling stream in line 173 to heat the reboiling stream to provide the reboiled stream in line 174 and a cooled aromatic column overhead stream in line 183. The cooled aromatic column overhead stream in line 183 may be passed to an overhead receiver 181 of the aromatic solvent column 180. The overhead receiver 181 may be operated at a temperature of about 60 °C (140 °F) to about 100 °C (212 °F). An offgas stream in line 184 may be vented from the receiver 181. An overhead liquid stream comprising the aromatic solvent may be taken from the overhead receiver 181 in line 185. A reflux stream in line 186 may be taken from the overhead liquid stream and recycled to the aromatic solvent column 180 near the top of the column. A recycle aromatic solvent stream may be taken in line 187. recycled

A lignin derived stream may be taken from the bottom of the aromatic solvent column 180 in line 188. In an aspect, the lignin derived stream in line 178 may comprise lignin oil. A reboiling stream in a reboil line 189 may be taken from the bottom lignin derived stream. The reboiling stream in line 189 may be reboiled in a reboiler 191 with a suitable heating media to provide a reboiled stream in line 194. The reboiled stream in line 194 is recycled back to the aromatic solvent column 180 near the bottom. The remainder of the lignin derived stream may be taken in line 192. The lignin derived stream in line 192 may be hydroprocessed to produce aromatics and/or alkanes.

The recycle aromatic solvent stream in line 187 may be recycled to the reactor 110. In an embodiment, the recycle aromatic solvent stream in line 187 may be combined with the solvent stream in line 104 to provide the combined solvent stream in line 106 and charged to the reactor 110 as earlier described.

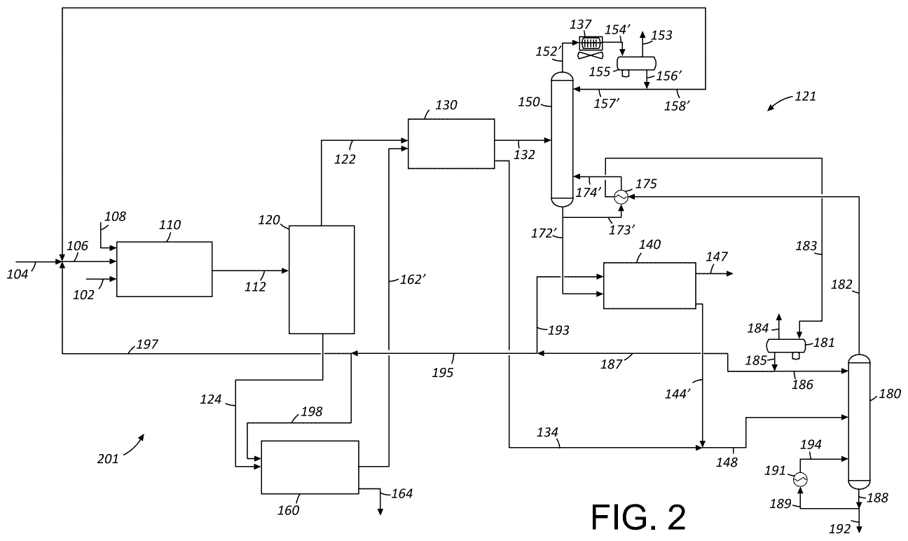

FIG. 2 shows another exemplary embodiment of the process for converting a lignocellulosic biomass 201. Elements in FIG. 2 with the same configuration as in FIG. 1 will have the same reference numeral as in FIG. 1. Elements in FIG. 2 which have a different configuration as the corresponding element in FIG. 1 will have the same reference numeral but designated with a prime symbol (′). The configuration and operation of the embodiment of FIG. 2 is essentially the same as in FIG. 1 with the following exceptions.

In the embodiment as shown in FIG. 2, the process 201 comprises feeding the first stream in line 132 to the alcohol recovery column 150 and the bottom stream of the alcohol recovery column 150 may be fed to the washing column 140. As shown in FIG. 2, the first stream in line 132 may be fed to the alcohol recovery column 150. In the alcohol recovery column 150, the alcohol is separated from the heavier sugars. An overhead stream comprising the alcohol in line 152′ may be cooled in a cooler condenser 137 and partially condensed to produce a cooled overhead stream in line 154′ and passed to an overhead receiver 155 of the alcohol recovery column 150. An offgas stream in line 153 may be vented from the receiver 155. An overhead liquid stream comprising the alcohol may be taken from the overhead receiver in line 156′. A reflux stream in line 157′ may be taken from the overhead liquid stream and recycled to the alcohol recovery column 150 near the top of the column. A recycle alcohol stream may be taken in line 158′ and recycled to the reactor 110. The recycle alcohol stream in line 158′ may be combined with the solvent stream in line 104 and charged to the reactor 110 in line 106.

An aqueous sugar stream may be taken in line 172′ from the bottom of the alcohol recovery column 150. A reboiling stream in a reboil line 173′ may be taken from the bottom aqueous sugar stream. The reboiling stream in line 173′ may be reboiled in a reboiler 175 with the aromatic column overhead stream in line 182 to provide a reboiled stream in line 174′ and a cooled aromatic column overhead stream in line 183. The reboiled stream in line 174′ is recycled back to the alcohol recovery column 150 near the bottom. As shown in FIG. 2, the remainder of the aqueous sugar stream in line 172′ may be fed to the washing column 140.

In the embodiment as shown in FIG. 2, a washing stream in line 193 may be taken from the recycle aromatic solvent stream in line 187 to wash the aqueous sugar stream in line 172′. The aqueous sugar stream in line 172′ may be fed to the washing column 140 near the bottom of the column. In an exemplary embodiment, a washing aromatic solvent stream in line 193 may be taken from the recycle aromatic solvent stream in line 187 and fed to the washing column 140. The washing aromatic solvent stream in line 193 may be fed to the washing column 140 near the top of the column. In the washing column 140, the aqueous sugar stream in line 172′ may be washed with the washing aromatic solvent stream in line 193. After washing, a washed sugar stream may be taken in line 147 from the washing column 140. A contacted aromatic solvent stream may be discharged in line 144′ from the washing column 140. In an embodiment, the aqueous sugar stream in line 172′ may be counter-currently contacted with the washing aromatic solvent stream in line 193 in the washing column 140. In such an embodiment, the contacted aromatic solvent stream in line 144′ may be taken from the bottom of the washing column 140 and the washed sugar stream in line 147 may be taken from the overhead of the washing column 140. In an embodiment, the contacted aromatic solvent stream in line 144′ may combined with the second stream in line 134 to provide the combined second stream in line 148 and fed to the aromatic solvent column 180 as earlier described in FIG. 1.

The remainder of the recycle aromatic solvent stream from line 187 may be taken in line 195 and recycled to the reactor 110 in solvent line 197. In an aspect, the solids containing stream in line 124 may be washed with the recycle aromatic solvent stream in line 195. In an exemplary embodiment, a second washing aromatic solvent stream in line 198 may be taken from the recycle aromatic solvent stream in line 195. The solids containing stream in line 124 and the second washing aromatic solvent stream in line 198 may be fed to the solids washing column 160. In an embodiment, the solids containing stream in line 124 may be cooled to a temperature of about 30 °C (86 °F) to about 60 °C (140 °F) before feeding into the solids washing column 160. The solids containing stream in line 124 may be fed near the bottom of the solids washing column 160 and the second washing aromatic solvent stream in line 198 may be fed near the top of the solids washing column 160. The ratio of the second washing aromatic solvent stream in line 198 to the solids in the solids washing column 160 may range from about 2:1 to about 5:1 by weight. In the solids washing column 160, the solids containing stream in line 124 may be contacted counter-currently with the second washing aromatic solvent stream in line 198 to wash the solvent off the solids. Washed solids may be taken in line 164 from the bottom of the solids washing column 160. A contacted second washing aromatic solvent stream may be taken from the overhead of the solids washing column 160 in line 162′. In an exemplary embodiment, the contacted second washing aromatic solvent stream in line 162′ may be charged to the two-phase separator 130.

The remainder of the recycle aromatic solvent stream from line 195 may be taken in line 197 and recycled to the reactor 110. The recycle aromatic solvent stream in line 197 may be combined with the aromatic solvent stream in line 104 and charged to the reactor 110 in line 106 as previously described. The rest of the process is the same as previously described in FIG. 1.

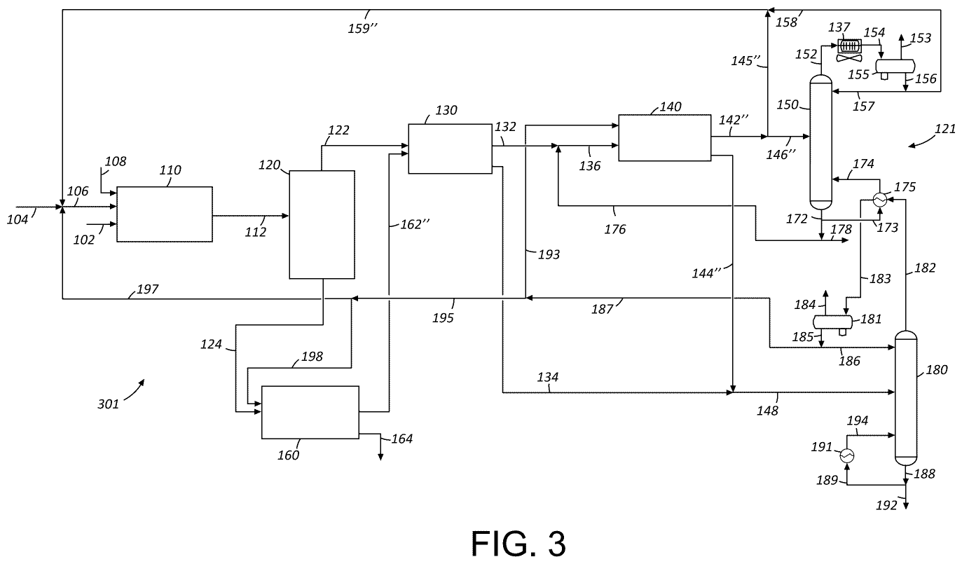

FIG. 3 shows another exemplary embodiment of the process for converting a lignocellulosic biomass 301. Elements in FIG. 3 with the same configuration as in FIG. 1 will have the same reference numeral as in FIG. 1. Elements in FIG. 3 which have a different configuration as the corresponding element in FIG. 1 will have the same reference numeral but designated with a double prime symbol (″). The configuration and operation of the embodiment of FIG. 3 is essentially the same as in FIG. 1 with the following exceptions.

In the embodiment as shown in FIG. 3, the process 301 comprises charging the first stream in line 132 first to the washing column 140 and thereafter to the alcohol recovery column 150. As shown in FIG. 3, the first stream in line 132 may be fed to the washing column 140 for separating the aromatic solvent. The recycle aqueous sugar stream in line 176 may be combined with the first stream in line 132 to provide the combined first stream in line 136 which is fed to the washing column 140. In an exemplary embodiment, the combined first stream in line 136 may be fed to the washing column 140 near the bottom of the column. In the washing column 140, the combined first stream may be washed with a washing stream taken from the overhead of the aromatic solvent column.

In the embodiment as shown in FIG. 3, a washing aromatic solvent stream in line 193 may be taken from the recycle aromatic solvent stream in line 187 and passed to the washing column 140. The washing aromatic solvent stream in line 193 may be fed to the washing column 140 near the top of the column. In the washing column 140, the combined first stream may be washed with the washing aromatic solvent stream in line 193 to remove the aromatic solvent from the alcohol and sugars. A washed first stream comprising the alcohol, water, and the sugars may be taken in line 142″ from the washing column 140. A contacted aromatic solvent stream may be taken in line 144″ from the washing column 140. In an embodiment, the combined first stream in line 136 may be counter-currently contacted with the washing aromatic solvent stream in line 193 in the washing column 140. In such an embodiment, the contacted aromatic solvent stream in line 144″ may be taken from the bottom of the washing column 140 and the washed first stream may be taken in line 142″ from the overhead of the washing column 140.

A bypass stream may be taken in a bypass line 145″ from the washed first stream in line 142″. The remainder of the washed first stream may be taken in line 146″ and fed to the alcohol recovery column 150. In the alcohol recovery column 150, the alcohol is separated from the heavier sugars. The recycle alcohol stream in line 158 may be taken from the overhead of the alcohol recovery column 150 and combined with the bypass stream in line 145″ to provide a combined recycle alcohol stream in line 159″. The combined recycle alcohol stream in line 159″ may be recycled to the reactor 110. The combined recycle alcohol stream in line 159″ may be combined with the solvent stream in line 104 and charged to the reactor 110 in line 106 as previously described.

The contacted aromatic solvent stream in line 144″ may combined with the second stream in line 134 to provide the combined second stream in line 148 and fed to the aromatic solvent column 180. The remainder of the recycle aromatic solvent stream from line 187 not refluxed to the aromatic solvent column 180 in line 186 may be taken in line 195 and recycled to the reactor 110 in solvent line 197. In an aspect, the solids containing stream in line 124 may be washed with the recycle aromatic solvent stream in line 195. In an exemplary embodiment, a second washing aromatic solvent stream in line 198 may be taken from the recycle aromatic solvent stream in line 195. The solids containing stream in line 124 and the second washing aromatic solvent stream in line 198 may be fed to the solids washing column 160. The solids containing stream in line 124 may be fed near the bottom of the solids washing column 160 and the second washing aromatic solvent stream in line 198 may be fed near the top of the solids washing column 160. The ratio of the second washing aromatic solvent stream in line 198 to the solids in the solids washing column 160 may range from about 2:1 to about 5:1 by weight. In the solids washing column 160, the solids containing stream in line 124 may be contacted counter-currently with the second washing aromatic solvent stream in line 198 to wash the solvent off the solids. Washed solids may be taken in line 164 from the bottom of the solids washing column 160. A contacted second washing aromatic solvent stream may be taken from the overhead of the solids washing column 160 in line 162″. In an exemplary embodiment, the contacted second washing aromatic solvent stream in line 162″ may be charged to the two-phase separator 130. The rest of the process is the same as earlier described in FIG. 1.

### EXAMPLES

### Example 1

A biomass feed stream and a solvent stream were mixed. The solvent stream comprised methanol as an alcohol solvent and toluene as an aromatic solvent. The solvent stream had 44 wt % methanol, 44 wt % toluene, and 12% water. The mixed feed stream comprising biomass feed stream, methanol, and toluene was heated and fed to the reactor containing a sulfided catalyst in the presence of hydrogen. The reactor was operated at a temperature of 225 °C, a pressure of 7584 kPag (1100 psig), and a residence time of 3 hours. The reactor effluent stream was fed to the solids separator to removed solids. Solids were removed and taken from the bottom of the solids separator. The two-phase liquid stream was removed from the solids separator and analyzed. The lignin conversion of the feed was observed to be 65%, which included 37% monomers and 63% dimers. The cellulose conversion was 25% and the overall hydrocarbon conversion was 85%.

### Example 2

The energy intensity of the present process with two-solvent system was compared with a single solvent system. For this, the energy required for the separation of components from the lignocellulosic biomass using the two-solvent system of the present process was compared with the single solvent system. Energy required for the separation of components using a single solvent system was taken from supporting information in the following reference: A. Bartling et al., “Techno-Economic Analysis and Life Cycle Assessment of a Biorefinery Utilizing Reductive Catalytic Fractionation”, Energy Env. Sci. 14, 4147-4168 (2021).

For the two-solvent system of the present process, data was generated from Unisim process simulation. The energy required for the two-solvent system was measured and compared with the supporting information for the single solvent system. The comparison is provided in the Table below:

TABLE

| | | Energy | % of biomass |
|---|---|---|---|
| | | required | energy required |
| Solvent system | Solvent name | (GJ/hr) | for separation |
| Single-solvent | Methanol | 1062 | 72.8 |
| system from | Ethanol | 927 | 63.5 |
| reference | Ethylene Glycol | 1138 | 78.8 |
| Two-solvent | Methanol-toluene | 164 | NA |
| system of | | | |
| the process | | | |

As evident from the results in the Table, the two-solvent system of the present process requires much lower energy for the separation of components from the lignocellulosic biomass than required for the single solvent system due in part to the heat integration between methanol and toluene separations.

### SPECIFIC EMBODIMENTS

While the following is described in conjunction with specific embodiments, it will be understood that this description is intended to illustrate and not limit the scope of the preceding description and the appended claims.

A first embodiment of the present disclosure is a process for converting a lignocellulosic biomass, comprising charging a lignocellulosic biomass stream and a solvent stream to a reactor, wherein the solvent stream comprises an alcohol and an aromatic; contacting the lignocellulosic biomass stream and the solvent stream with a catalyst in the presence of hydrogen to produce a reactor effluent stream; separating the reactor effluent stream into a first stream comprising the alcohol and a second stream comprising the aromatic and a lignin derived stream; and separating an aromatic solvent stream from the lignin derived stream in an aromatic solvent column to produce said lignin derived stream. An embodiment of the present disclosure is one, any or all of prior embodiments in this paragraph up through the first embodiment in this paragraph, wherein the alcohol has no more than four carbon atoms. An embodiment of the present disclosure is one, any or all of prior embodiments in this paragraph up through the first embodiment in this paragraph, wherein the first stream further comprises sugars. An embodiment of the present disclosure is one, any or all of prior embodiments in this paragraph up through the first embodiment in this paragraph, wherein the aromatic comprises six to twenty carbon atoms. An embodiment of the present disclosure is one, any or all of prior embodiments in this paragraph up through the first embodiment in this paragraph further comprising separating solids from the reactor effluent stream to provide a two-phase stream; and separating the two-phase stream to produce the first stream and the second stream. An embodiment of the present disclosure is one, any or all of prior embodiments in this paragraph up through the first embodiment in this paragraph further comprising washing the first stream to separate aromatic solvent to produce a washed stream and a contacted aromatic solvent stream; and passing the washed stream to an alcohol recovery column to produce an overhead alcohol stream and a bottom stream comprising aqueous sugars. An embodiment of the present disclosure is one, any or all of prior embodiments in this paragraph up through the first embodiment in this paragraph further comprising passing the contacted aromatic solvent stream to the aromatic solvent column. An embodiment of the present disclosure is one, any or all of prior embodiments in this paragraph up through the first embodiment in this paragraph, wherein the alcohol recovery column is operated at a lower overhead pressure than the aromatic solvent column. An embodiment of the present disclosure is one, any or all of prior embodiments in this paragraph up through the first embodiment in this paragraph, wherein the alcohol stream comprises from about 3 wt % to about 15 wt % water. An embodiment of the present disclosure is one, any or all of prior embodiments in this paragraph up through the first embodiment in this paragraph, wherein the reaction conditions inside the reactor comprises a solvent to biomass ratio of about 3:2 to about 5:1 by weight. An embodiment of the present disclosure is one, any or all of prior embodiments in this paragraph up through the first embodiment in this paragraph, wherein the reactor is operated at a pressure of no more than about 15000 kPa (gauge). An embodiment of the present disclosure is one, any or all of prior embodiments in this paragraph up through the first embodiment in this paragraph, wherein the first stream is washed with a washing stream comprising an aromatic solvent. An embodiment of the present disclosure is one, any or all of prior embodiments in this paragraph up through the first embodiment in this paragraph, wherein the first stream comprises about 5 wt % to about 15 wt % aromatic solvent.

A second embodiment of the present disclosure is a process for converting a lignocellulosic biomass, comprising charging a lignocellulosic biomass stream and a solvent stream to a reactor, wherein the solvent stream comprises an alcohol and an aromatic; contacting the lignocellulosic biomass stream and the solvent stream with a catalyst in the presence of hydrogen to produce a reactor effluent stream, wherein the reactor comprises a solvent to biomass ratio of about 3:2 to about 5:1 by weight; separating the reactor effluent stream into a first stream comprising the alcohol and a second stream comprising the aromatic and a lignin derived stream; and separating the aromatic solvent from lignin derived stream in an aromatic solvent column to produce the lignin derived stream. An embodiment of the present disclosure is one, any or all of prior embodiments in this paragraph up through the second embodiment in this paragraph further comprising mixing the lignocellulosic biomass stream and the solvent stream to provide a mixed stream comprising a solvent to biomass ratio of about 3:2 to about 5:1 by weight; and charging the mixed stream into the reactor. An embodiment of the present disclosure is one, any or all of prior embodiments in this paragraph up through the second embodiment in this paragraph further comprising heating the mixed stream in a heater to produce a heated mixed stream; and charging the heated mixed stream into the reactor. An embodiment of the present disclosure is one, any or all of prior embodiments in this paragraph up through the second embodiment in this paragraph, wherein the reactor effluent stream comprises a dimers to monomers ratio of greater than about 1:1 by weight.

A third embodiment of the present disclosure is a process for converting a lignocellulosic biomass, comprising contacting a lignocellulosic biomass stream and a solvent stream with a catalyst in the presence of hydrogen to produce a reactor effluent stream; separating the reactor effluent stream into a first stream comprising the alcohol and a second stream comprising the aromatic and a lignin derived effluent; separating alcohol from the first stream in an alcohol recovery column and separating aromatic solvent from the second stream in an aromatic solvent column; and heating a reboiling stream of the alcohol recovery column in a reboiler by heat exchange with an overhead stream of the aromatic solvent column. An embodiment of the present disclosure is one, any or all of prior embodiments in this paragraph up through the first embodiment in this paragraph further comprising charging the second stream to the aromatic solvent column; separating the second stream in the aromatic solvent column to produce an aromatic column overhead stream comprising aromatic solvent and a lignin derived stream; and passing the aromatic column overhead stream to the reboiler of the alcohol recovery column to heat the reboiling stream and provide a cooled aromatic column overhead stream. An embodiment of the present disclosure is one, any or all of prior embodiments in this paragraph up through the first embodiment in this paragraph, wherein the alcohol recovery column is operated at a lower overhead pressure than the aromatic solvent column.

A fourth embodiment of the present disclosure is a process for converting a lignocellulosic biomass, comprising charging a lignocellulosic biomass stream and a solvent stream to a reactor, the solvent stream comprising an alcohol having no more than four carbon atoms and an aromatic having six to twenty carbon atoms; contacting the lignocellulosic biomass stream and the solvent stream with hydrogen in the presence of a catalyst to produce a reactor effluent stream; separating the reactor effluent stream into a first stream comprising the alcohol and a second stream comprising the aromatic and a lignin derived stream; and separating the aromatic solvent stream from the lignin derived stream in an aromatic solvent to produce the lignin derived stream. An embodiment of the present disclosure is one, any or all of prior embodiments in this paragraph up through the fourth embodiment in this paragraph further comprising washing the first stream to separate aromatic solvent and produce a washed stream and a contacted aromatic solvent stream; and passing the washed stream to an alcohol recovery column to produce an overhead alcohol stream and a bottom stream comprising sugars. An embodiment of the present disclosure is one, any or all of prior embodiments in this paragraph up through the third embodiment in this paragraph further comprising passing the contacted aromatic solvent stream to the aromatic solvent column.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for converting a lignocellulosic biomass, comprising:
charging a lignocellulosic biomass stream and a solvent stream to a reactor, wherein said solvent stream comprises an alcohol and an aromatic;
contacting said lignocellulosic biomass stream and said solvent stream with a catalyst in the presence of hydrogen to produce a reactor effluent stream;
separating said reactor effluent stream into a first stream comprising said alcohol and a second stream comprising said aromatic and a lignin derived stream; and
separating an aromatic solvent stream from said lignin derived stream in an aromatic solvent column to produce a lignin derived stream.

2. The process of claim 1, wherein said alcohol has no more than four carbon atoms.

3. The process of claim 1, wherein said first stream further comprises sugars.

4. The process of claim 1, wherein said aromatic comprises six to twenty carbon atoms.

5. The process of claim 1 further comprising:
separating solids from said reactor effluent stream to provide a two-phase stream; and
separating said two-phase stream to produce said first stream and said second stream.

6. The process of claim 1 further comprising:
washing said first stream to separate aromatic solvent to produce a washed stream and a contacted aromatic solvent stream; and
passing said washed stream to an alcohol recovery column to produce an overhead alcohol stream and a bottom stream comprising aqueous sugars.

7. The process of claim 6 further comprising passing said contacted aromatic solvent stream to the aromatic solvent column.

8. The process of claim 6, wherein the alcohol recovery column is operated at a lower overhead pressure than the aromatic solvent column.

9. The process of claim 1, wherein said alcohol stream comprises from about 3 wt % to about 15 wt % water.

10. The process of claim 1, wherein the reaction conditions inside the reactor comprises a solvent to biomass ratio of about 3:2 to about 5:1 by weight.

11. The process of claim 1, wherein the reactor is operated at a pressure of no more than about 15000 kPa (gauge).

12. The process of claim 6, wherein said first stream is washed with a washing stream comprising an aromatic solvent.

13. The process of claim 1, wherein said first stream comprises about 5 wt % to about 15 wt % aromatic solvent.

14. A process for converting a lignocellulosic biomass, comprising:
charging a lignocellulosic biomass stream and a solvent stream to a reactor, wherein said solvent stream comprises an alcohol and an aromatic;
contacting said lignocellulosic biomass stream and said solvent stream with a catalyst in the presence of hydrogen to produce a reactor effluent stream, wherein the reactor comprises a solvent to biomass ratio of about 3:2 to about 5:1 by weight;
separating said reactor effluent stream into a first stream comprising said alcohol and a second stream comprising said aromatic and a lignin derived stream; and
separating the aromatic solvent from said lignin derived stream in an aromatic solvent column to produce a lignin derived stream.

15. The process of claim 14 further comprising:
mixing said lignocellulosic biomass stream and said solvent stream to provide a mixed stream comprising a solvent to biomass ratio of about 3:2 to about 5:1 by weight; and
charging said mixed stream into the reactor.

16. The process of claim 15 further comprising:
heating said mixed stream in a heater to produce a heated mixed stream; and
charging said heated mixed stream into the reactor.

17. The process of claim 14, wherein said reactor effluent stream comprises a dimers to monomers ratio of greater than about 1:1 by weight.

18. A process for converting a lignocellulosic biomass, comprising:
contacting a lignocellulosic biomass stream and a solvent stream with a catalyst in the presence of hydrogen to produce a reactor effluent stream;
separating said reactor effluent stream into a first stream comprising said alcohol and a second stream comprising said aromatic and a lignin derived effluent;
separating alcohol from said first stream in an alcohol recovery column and separating aromatic solvent from said second stream in an aromatic solvent column; and
heating a reboiling stream of the alcohol recovery column in a reboiler by heat exchange with an overhead stream of the aromatic solvent column.

19. The process of claim 18 further comprising:
charging said second stream to the aromatic solvent column;
separating said second stream in the aromatic solvent column to produce an aromatic column overhead stream comprising aromatic solvent and a lignin derived stream; and
passing said aromatic column overhead stream to the reboiler of the alcohol recovery column to heat said reboiling stream and provide a cooled aromatic column overhead stream.

20. The process of claim 18, wherein the alcohol recovery column is operated at a lower overhead pressure than the aromatic solvent column.
